(19) United States
(12) Patent Application Publication
(10) Pub. No.: US 2026/0003021 A1
(43) Pub. Date: Jan. 1, 2026

(54) WIRELESS LOCATOR

(71) Applicant: ASAP TECHNOLOGY (JIANGXI) CO., LIMITED., Jiangxi Province (CN)

(72) Inventors: Kaizhuo Chen, Jiangxi Province (CN); Xiongwu Li, Jiangxi Province (CN)

(73) Assignee: ASAP TECHNOLOGY (JIANGXI) CO., LIMITED., Jiangxi Province (CN)

(21) Appl. No.: 19/203,848

(22) Filed: May 9, 2025

(30) Foreign Application Priority Data
Jun. 28, 2024 (CN) 202410864814.3

(51) Int. Cl. G01S 1/02; G01S 1/04

(52) U.S. Cl. CPC G01S 1/024; G01S 1/0423

(57) ABSTRACT

Provided is a wireless locator. The wireless locator includes a locator body and a charging connector movably connected to the locator body. The locator body includes an accommodation groove and a first electrical connection structure. The charging connector includes a second electrical connection structure and a plug-in tongue which may be accommodated in the accommodation groove. When the wireless locator is charged, the plug-in tongue is taken out from the accommodation groove, the first electrical connection structure of the locator body and the second electrical connection structure of the charging connector are connected, and the plug-in tongue is connected to an external charging interface. In this way, a rechargeable battery in the wireless locator is charged.

### CROSS-REFERENCE TO RELATED APPLICATION

This application claims the benefit of Chinese Patent Application No. 202410864814.3, filed on Jun. 28, 2024, entitled “Wireless Locator”, which is incorporated herein by reference in its entirety.

### FIELD OF DISCLOSURE

The present disclosure relates to the wireless positioning technology, more particularly, to a wireless locator.

### BACKGROUND

At present, people use more and more products in their daily life, and the positioning of product is more and more important. Current satellite positioning system cannot meet the accuracy requirements of indoor short-range positioning. Positioning technology based on short-distance wireless communication technology (for example, Zigbee, RFID, WiFi, Bluetooth, UWB) is also gradually developing, providing a new small-range high-precision indoor positioning method.

At present, the wireless locator based on short-distance wireless communication is powered by a battery. The battery may be a built-in non-rechargeable battery, a replaceable battery, or a built-in rechargeable battery. Currently, in order to reduce the thickness of the wireless locator, the wireless locator powered by the built-in rechargeable battery employs a metal contact as an input for receiving electrical power. This wireless locator is charged by a dedicated charger, which reduces the charging flexibility of the wireless locator and is not user-friendly.

### SUMMARY

The present disclosure provides a wireless locator having a good charging flexibility. The wireless locator includes: a locator body and a charging connector moveably connected to the locator body. The locator body includes a notch, a first electrical connection structure, and a rechargeable battery electrically connected to the first electrical connection structure. The notch includes at least one side wall and a bottom wall connected to the at least one side wall, the bottom wall includes an accommodation groove. The charging connector includes an operable part, a second electrical connection structure, and a plug-in tongue. The plug-in tongue is connected to the operable part, and the second electrical connection structure is electrically connected to the plug-in tongue. The charging connector has an accommodated position and an operation position. When the charging connector is in the accommodated position, the operable part is accommodated in the notch, the plug-in tongue is accommodated in the accommodation groove, and the second electrical connection structure is separated from the first electrical connection structure. When the charging connector is in the operation position, the plug-in tongue is out of the accommodation groove and protrudes from the locator body, and the second electrical connection structure is connected to the first electrical connection structure.

In some embodiments, each side wall includes a first guide structure, an extending direction of the first guide structure intersects the bottom wall, the operable part includes a second guide structure, and the second guide structure and the first guide structure are in a sliding connection.

In some embodiments, the at least one side wall of the notch includes a first side wall and a second side wall, the first side wall and the second side wall are spaced apart and disposed opposite to each other, the bottom wall is connected to the first side wall and the second side wall, and the operable part is disposed between the first side wall and the second side wall. The operable part includes two second guide structures, one of the two second guide structures cooperates with the first guide structure of the first side wall, and the other one of the two second guide structures cooperates with the first guide structure of the second side wall.

In some embodiments, the first guide structure is a guide groove, an extending direction of the guide groove intersects the bottom wall, the second guide structure is a guide bump, and the guide groove and the guide bump are in a sliding connection.

In some embodiments, the sliding connection of the guide groove and the guide bump has a first relative position and a second relative position, when the charging connector is in the accommodated position, the guide groove and the guide bump are located in the first relative position, and when the guide groove and the guide bump are located in the second relative position, the charging connector has a rotational degree of freedom that the charging connector is rotatable with respect to the locator body with the guide bump as an axis.

In some embodiments, the first guide structure is a guide bump, the second guide structure is a guide groove, and the guide groove and the guide bump are in a sliding connection.

In some embodiments, the sliding connection of the guide groove and the guide bump has a first relative position and a second relative position, when the charging connector is in the accommodated position, the guide groove and the guide bump are located in the first relative position, and when the guide groove and the guide bump are located in the second relative position, the charging connector has a rotational degree of freedom that the charging connector is rotatable with respect to the locator body with the guide bump as an axis.

In some embodiments, the first electrical connection structure includes a conductive pin arranged on the side wall, the conductive pin is spaced apart from the first guide structure and arranged on a side of the first guide structure close to the bottom wall, and the second electrical connection structure is arranged on a side of the second guide structure away from the plug-in tongue.

In some embodiments, the charging connector is rotatably connected to the locator body through a rotation shaft, and the rotation shaft is perpendicular to a depth direction of the accommodation groove.

In some embodiments, the charging connector further includes a connection part, the connection part is disposed on a side of the operable part and is rotatably connected to the locator body through the rotation shaft, and the connection part avoids the plug-in tongue.

In some embodiments, the side wall is further provided with an avoidance groove, the connection part is arranged in the avoidance groove, and the rotation shaft runs through the connection part and two opposite walls of the avoidance groove.

In some embodiments, the first electrical connection structure includes a conductive elastic piece, the second electrical connection structure includes a connection arm, the connection arm is arranged on a side of the connection part away from the operable part, and the conductive elastic piece is arranged on a trajectory of rotation of the connection arm around the rotation shaft.

In some embodiments, the conductive elastic piece includes two protruding portions and a recessed portion between the two protruding portions, the two protruding portions are arranged on the trajectory of rotation of the connection arm around the rotation shaft, when the charging connector is in the operation position, the connection arm is in contact with the recessed portion, and when the charging connector moves between the accommodated position and the operation position, the connection arm presses the protruding portions to cause elastic deformation of the protruding portions.

In some embodiments, the operable part includes a first end and a second end opposite to the first end, the plug-in tongue is arranged on the first end, the operable part is further provided with a first magnetic member, and the bottom wall is provided with a second magnetic member. When the charging connector is in the operation position, the second end and the bottom wall are connected by magnetic attachment of the first magnetic member and the second magnetic member, and/or, when the charging connector is in the accommodated position, the first end and the bottom wall are connected by magnetic attachment of the first magnetic member and the second magnetic member.

In some embodiments, the locator body further includes a first connection member, the charging connector includes a second connection member, and when the charging connector is in the operation position, the first connection member is connected to the second connection member.

In some embodiments, the locator body further includes a control circuit electrically connected to the rechargeable battery, the control circuit includes a power management circuit and a positioning circuit, the power management circuit is electrically connected to the first electrical connection structure and the rechargeable battery, and the positioning circuit is in wireless communication with an external device.

In some embodiments, the locator body further includes a sounding device electrically connected to the control circuit.

In some embodiments, the wireless locator has an extended flat box shape, the notch runs through the locator body along a thickness direction of the wireless locator, and when the plug-in tongue is accommodated in the accommodation groove, the plug-in tongue is perpendicular to the thickness direction of the wireless locator.

Embodiments of the present disclosure provide a wireless locator. The wireless locator includes a locator body and a charging connector. The charging connector is moveably connected to the locator body. The charging connector includes a plug-in tongue. The plug-in tongue may be accommodated in the accommodation groove of the locator body, ensuring the neatness and cleanliness of the appearance of the wireless locator. When the wireless locator is being charged, the plug-in tongue is moved out from the accommodation groove, the first electrical connection structure of the locator body is connected to the second electrical connection structure of the charging connector, and the plug-in tongue is connected to an external power interface. In this way, the rechargeable battery of the wireless locator is charged. The plug-in tongue may be a universal charging interface, which improves the charging flexibility of the wireless locator without increasing the thickness of the wireless locator.

### BRIEF DESCRIPTION OF DRAWINGS

The various features and advantages of the disclosed examples will become apparent to those skilled in the art from the detailed description. The figures that accompany the detailed description can be briefly described as follows:

FIG. 1 is a schematic perspective view of a wireless locator when a charging connector is in an accommodated position according to embodiments of the present disclosure;

FIG. 2 is a schematic perspective view of the wireless locator when the charging connector is in an operation position according to embodiments of the present disclosure;

FIG. 3 is a side view of the wireless locator according to embodiments of the present disclosure;

FIG. 4 is a schematic view of a locator body according to embodiments of the present disclosure;

FIG. 5 is a schematic perspective view of the charging connector according to embodiments of the present disclosure;

FIG. 6 is a top view of the charging connector according to embodiments of the present disclosure;

FIG. 7 is a schematic diagram of the wireless locator when the charging connector is in an accommodated position according to embodiments of the present disclosure;

FIG. 8 is a schematic diagram of the wireless locator when charging connector is in an operation position according to embodiments of the present disclosure;

FIG. 9 is a block diagram of the wireless locator according to embodiments of the present disclosure;

FIG. 10 is a schematic diagram showing the plug-in tongue moves out from the accommodation groove according to embodiments of the present disclosure;

FIG. 11 is a schematic perspective view showing the plug-in tongue moves out from the accommodation groove according to embodiments of the present disclosure;

FIG. 12 is a schematic perspective view of the wireless locator when the charging connector is in the accommodated position according to another embodiment of the present disclosure;

FIG. 13 is a schematic perspective view of the wireless locator when the charging connector is in the operation position according to another embodiment of the present disclosure;

FIG. 14 is a perspective view of the charging connector according to another embodiment of the present disclosure;

FIG. 15 is a perspective view of the wireless locator according to another embodiment of the present disclosure;

FIG. 16 is a schematic view showing the charging connector moves from the accommodated position to the operation position according to another embodiment of the present disclosure;

FIG. 17 is a partial cross-sectional view of the wireless locator when the charging connector is in the accommodated position according to another embodiment of the present disclosure; and

FIG. 18 is a partial cross-sectional view of the wireless locator when the charging connector is in the operation position according to another embodiment of the present disclosure.

### REFERENCE NUMERAL LIST

10: locator body; 11: notch; 111: side wall;
1111: first side wall; 1112: second side wall; 112: bottom wall;
1121: second magnetic member; 12: accommodation groove;
13: first electrical connection structure; 131: conductive pin;
132: conductive elastic member; 1321: protruding portion;
1322: recessed portion; 14: first guide structure; 15: avoidance groove;
16: rechargeable battery; 17: control circuit;
171: power management circuit; 172: positioning circuit;
18: sounding device; 20: charging connector; 21: operable part;
211: second guide structure; 212: first end; 213: second end;
214: first magnetic member; 22: second electrical connection structure;
221: connection arm; 23: plug-in tongue; 24: connection part;
30: rotation shaft.

### DETAILED DESCRIPTION

The present disclosure is described below on the basis of the embodiments, but is not merely limited to these embodiments. Specific details are described in detail in the following detailed description of the present disclosure. The present disclosure can also be fully understood by a person skilled in the art without the description of the details. In order to avoid confusing the essence of the present disclosure, commonly known method, process, flow, element and circuit are not described in detail.

In addition, it should be understood by those skilled in the art, the drawings herein are provided for the purpose of illustration, and the drawings are not necessarily to scale.

Unless otherwise stated, the terms “comprise”, “include” and the like in the entire application document shall be interpreted as inclusive rather than exclusive or exhaustive; in other words, the terms mean “include but not limited to”.

In the descriptions of the present disclosure, it should be understood that the terms like “first”, “second” and the like are used for the purpose of description only, but cannot be considered to indicate or imply relative importance. In addition, in the descriptions of the present disclosure, unless otherwise stated, the meaning of “a plurality of” is two or more.

Unless otherwise stated or defined, the terms “install”, “connected”, “connect”, “fix” and the like should be understood in a broad sense, for example, the term “connected” may be fixedly connected or detachably connected or integrally connected, may be mechanically connected or electrically connected, may be directly connected or indirectly connected by means of an intermediate medium, and may be internally communicated or have an interaction relationship between two elements. A person skilled in the art can understand the specific meanings of the above terms in the present disclosure according to specific circumstances.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

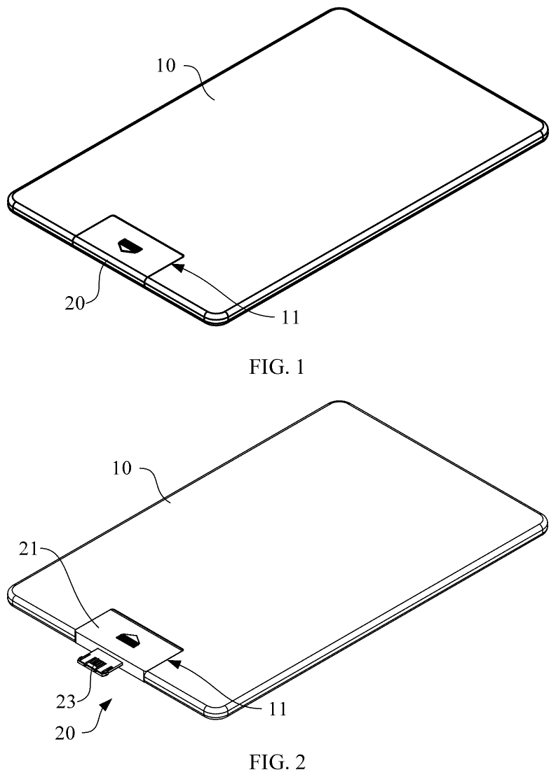

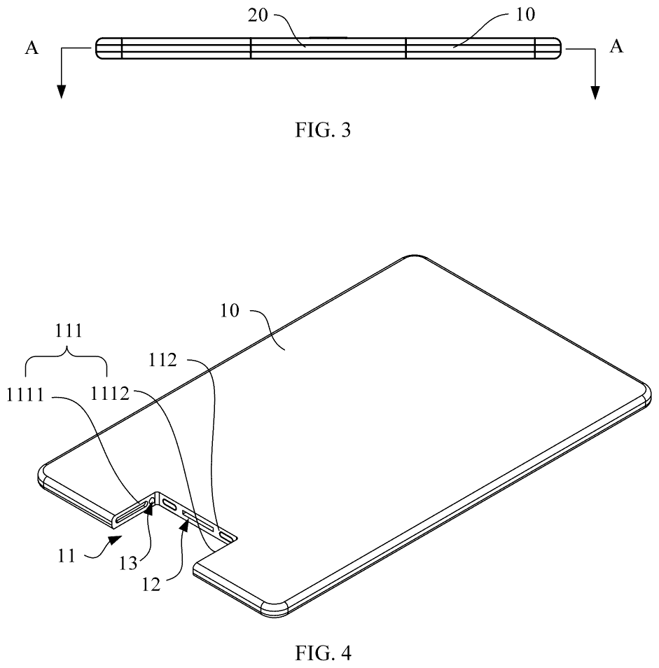

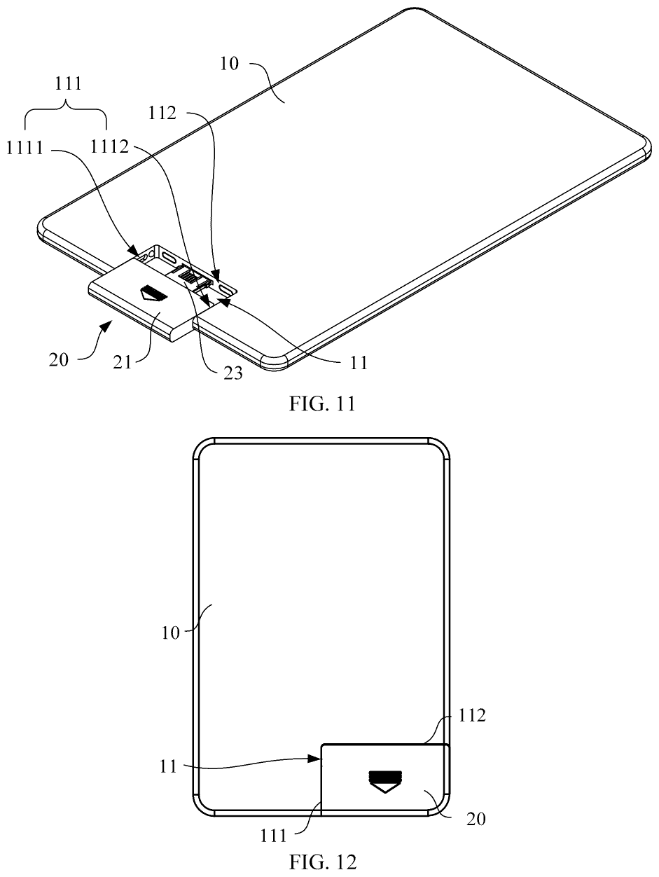

Embodiments of the present disclosure provide a wireless locator. FIG. 1 is a schematic perspective view of a wireless locator when a charging connector is in an accommodated position. FIG. 2 is a schematic perspective view of the wireless locator when the charging connector is in an operation position. FIG. 3 is a side view of the wireless locator. FIG. 11 is a schematic perspective view showing that a plug-in tongue moves out from the accommodation groove. As shown in FIG. 1 to FIG. 3 and FIG. 11, the wireless locator includes a locator body 10 and a charging connector 20 movably connected to the locator body 10. The locator body 10 includes a notch 11. The charging connector 20 may be arranged in the notch 11 and may be manipulated by a user to move relative to the notch 11. FIG. 4 is a schematic view of a locator body according to embodiments of the present disclosure. As shown in FIG. 4, the notch 11 includes at least one side wall 111 and a bottom wall 112 connected to the side wall 111. The bottom wall 112 includes an accommodation groove 12. The locator body 10 further includes a first electrical connection structure 13. The first electrical connection structure 13 is used for transmitting power to circuitries in the locator body 10.

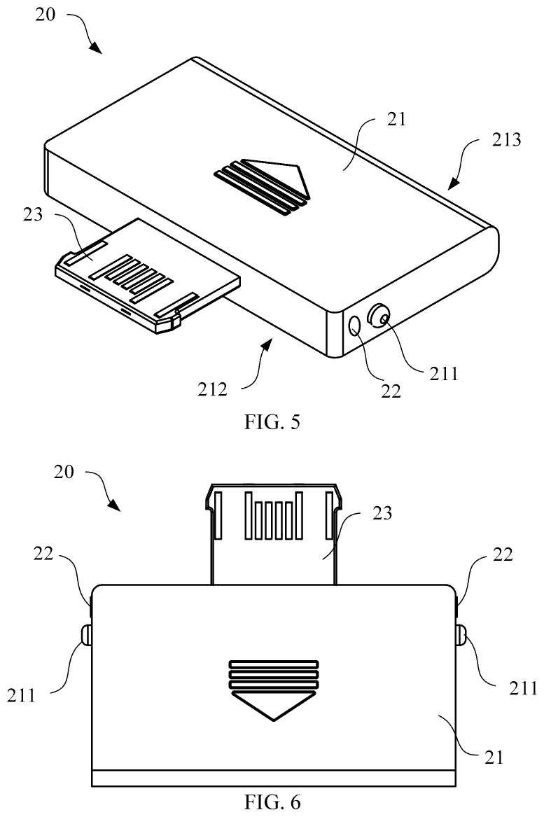

FIG. 5 is a schematic perspective view of the charging connector 20 according to embodiments of the present disclosure. FIG. 6 is a top view of the charging connector 20 according to embodiments of the present disclosure. As shown in FIG. 5 and FIG. 6, the charging connector 20 includes an operable part 21, a second electrical connection structure 22, and a plug-in tongue 23. The plug-in tongue 23 is connected to the operable part 21, and the second electrical connection structure 22 is electrically connected to the plug-in tongue 23. The plug-in tongue 23 is configured to be electrically connected to an external power source, for example, through an external connector. When the plug-in tongue 23 is electrically connected to an external power source through a connector, the first electrical connection structure 13 is electrically connected to the second electrical connection structure 22, the power is transmitted from the external power source to the locator body 10 through the charging connector 20, and thus, the locator body 10 is charged.

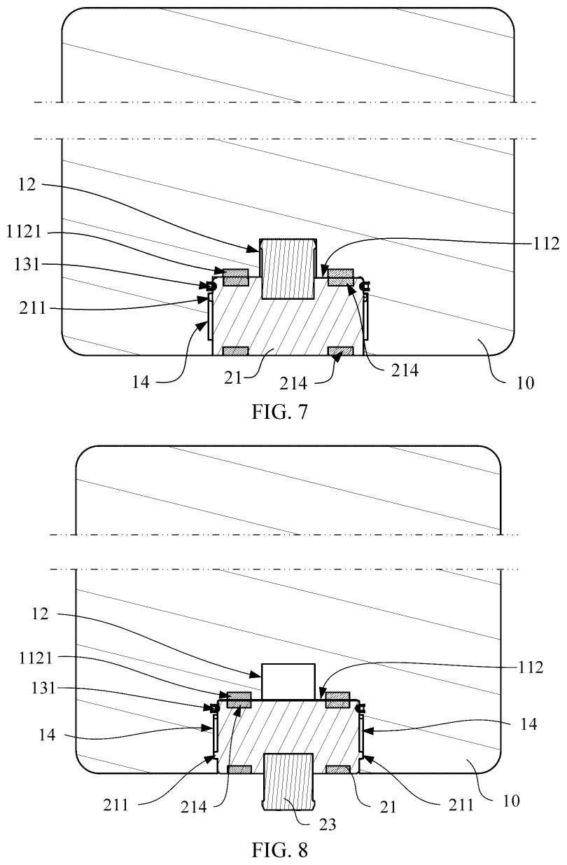

In embodiments of the present disclosure, the charging connector 20 of the wireless locator has an accommodated position and an operation position relative to the locator body 10. The charging connector 20 may switch between the accommodated position and the operation position by moving the operable part 21 by a user. FIG. 7 is a schematic diagram of the wireless locator when the charging connector is in an accommodated position according to embodiments of the present disclosure. FIG. 8 is a schematic diagram of the wireless locator when charging connector is in an operation position according to embodiments of the present disclosure. FIG. 10 is a schematic diagram showing the plug-in tongue moves out from the accommodation groove and is at a position between the accommodated position and the operation position according to embodiments of the present disclosure. FIG. 7, FIG. 8, and FIG. 10 are sectional views taken along a line A-A shown in FIG. 3. As shown in FIG. 1 and FIG. 7, when the charging connector 20 is in the accommodated position, the operable part 21 is in the notch 11. The shape of the operable part 21 and the shape of the notch 11 are complementary, so the operable part 21 fills up the notch 11, the wireless locator has a substantially rectangle shape in a top view, and the wireless locator has an integral appearance profile. When the charging connector 20 is in the accommodated position, the plug-in tongue 23 is accommodated in the accommodation groove 12, so the plug-in tongue 23 is hidden. In addition, the second electrical connection structure 22 is positioned away from the first connection structure 13, and is not electrically connected to the first connection structure 13. As shown in FIG. 2 and FIG. 8, when the charging connector 20 is in the operation position, the plug-in tongue 23 is out of the accommodation groove 12, and protrudes from the locator body 10, which is convenient for connection with the electrical connector interface of the external power source. When the charging connector 20 is in the operation position, the second electrical connection structure 22 is electrically connected to the first connection structure 13. When the plug-in tongue 23 is connected to the external power source, the wireless charger is powered.

For example, as shown in FIG. 5 and FIG. 6, the operable part 21 has a first end and a second end, and the plug-in tongue 23 protrudes from the first end. When the charging connector 20 is in the accommodated position, the first end is in contact with the bottom wall 112 of the notch 111. When the charging connector 20 is in the operation position, the second end is in contact with the bottom wall 112 of the notch 111.

The plug-in tongue 23 is designed according to actual needs. For example, the plug-in tongue 23 is designed according to the electronic device charging interface widely used on the market when the wireless locator is manufactured. In this way, the plug-in tongue 23 is applicable to the universal charging cable to charge the wireless locator. Therefore, there is no need to provide a dedicated charger for the wireless locator, and the user may charge the wireless charger with a charger he/she already has, which makes it easier for the user to charge the wireless charger while reducing resources consumed by manufacturing the charger dedicated for the wireless locator, and is conducive to environmental protection. For example, USB Type-C interface is the universal interface of the current electronic devices, and the plug-in tongue 23 may be a USB Type-C interface plug. The plug-in tongue 23 may be connected to a charging cable or a power supply device having the USB Type-C interface port so as to charge the wireless locator. It is noted that the plug-in tongue 23 is not limited to the USB Type-C interface plug, and those skilled in the art may select or design other universal interface type of the plug-in tongue 23 according to the development status of the interface standards when the technical solution in embodiments of the present disclosure is practiced.

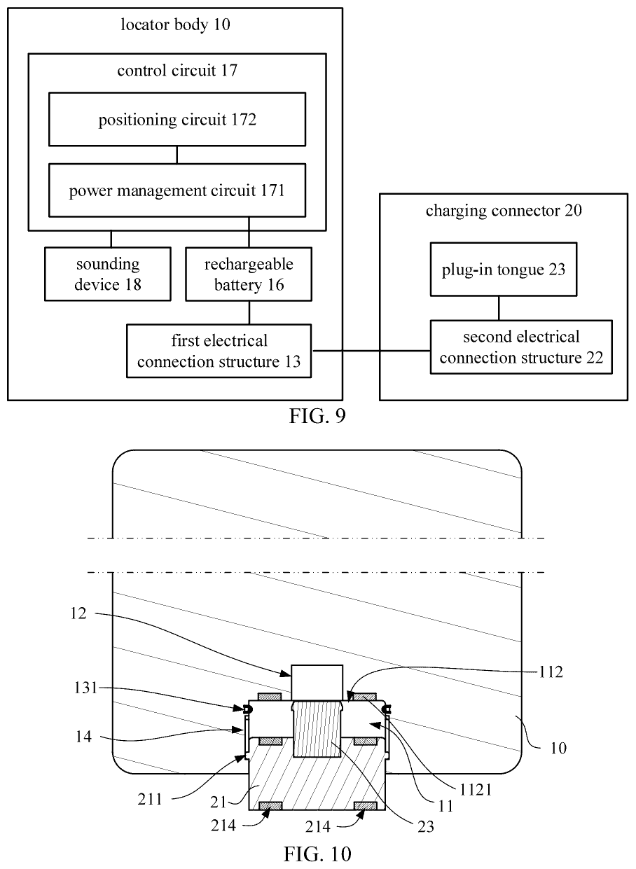

As shown in FIG. 9, the wireless locator further includes a rechargeable battery 16 and a control circuit 17. The rechargeable battery 16 is electrically connected to the control circuit 17. The control circuit 17 includes a power management circuit 171. The power management circuit 171 is electrically connected to the first electrical connection structure 13 and the rechargeable battery 16. When the wireless locator is charged with the charging connector 20, the rechargeable battery 16 receives charging current, which flows through the first electrical connection structure 13 and the power management circuit 171. The power management circuit 171 may manage the rechargeable battery 16, so that the rechargeable battery 16 transmits power to the electronic devices in the locator body 10. The power management circuit 171 may further provide charge protection and the like. The control circuit 17 may further include a positioning circuit 172 electrically connected to the rechargeable battery 16. The positioning circuit 172 is configured to be connected to an external device through wireless communication to realize positioning. For example, when the wireless locator includes a Bluetooth-Based positioning function, the positioning circuit 172 include a Bluetooth positioning circuit. The Bluetooth positioning circuit may be connected to an external Bluetooth positioning base station through wireless communication, and thus, the location of the wireless locator is determined. In some embodiments, through the wireless communication connection with the external base station, the positioning circuit 172 may send the position information of the positioning circuit 172 to a user terminal.

In some embodiments, the wireless locator further includes a sounding device 18. The sounding device 18 may be a speaker, a buzzer, or any other device capable of sounding. The sounding device 18 is electrically connected to the control circuit 17. The control circuit 17 may control the sounding device 18 to make sound, the sound is used for indicating to the user where the wireless locator is located, and thus, it is easier for the user to find the wireless locator. For example, when the wireless locator receives, from the base station, a calling signal that is sent by the user terminal, the control circuit 17 sends the position information of the wireless locator to the user through the positioning circuit 172 and the base station, and also causes the sounding device to make sound.

The shape of the wireless locator may be determined according to actual needs. For example, the shape of the wireless locator may be cylinder, sphere, cuboid, and the like. In some embodiments, the wireless locator has an extended flat box shape. For example, the wireless locator is formed into a size similar to a business card or credit card, which is easy to set up in various positions. The notch 11 runs through the locator body 10 along a thickness direction of the wireless locator. An opening of the accommodation groove 12 is arranged on a side of the wireless locator. When the plug-in tongue 23 is accommodated in the accommodation groove 12, the plug-in tongue 23 is substantially parallel to a side surface of the extended flat box shaped wireless locator. In other words, when the plug-in tongue 23 is accommodated in the accommodation groove 12, the plug-in tongue 23 is substantially perpendicular to the thickness direction of the extended flat box shaped wireless locator. Due to such arrangement, the space is fully utilized, the thickness of the wireless locator is reduced, and the wireless locator can be disposed in a narrow space or attached to a surface of an object.

As shown in FIG. 7, FIG. 8, and FIG. 10, the side wall 111 includes a first guide structure 14, an extending direction of the first guide structure 14 intersects the bottom wall 112, and the operable part 21 includes a second guide structure 211. The second guide structure 211 and the first guide structure 14 are in a sliding connection, so the movement of the charging connector 20 relative to the locator body 10 is smooth and easy to control. The form of the first guide structure 14 and the second guide structure 211 may select appropriate types according to the specific conditions such as shape, structure and so on of the wireless locator. In an embodiment, the first guide structure 14 and the second guide structure 211 are a sliding rail and a sliding block that match each other. In another embodiment, as shown in FIG. 7, FIG. 8, and FIG. 10, the first guide structure 14 is a guide groove, an extending direction of the guide groove intersects the bottom wall 112, the second guide structure 211 is a guide bump, and the guide bump extends into the guide groove and can slide along the guide groove. In another embodiment, the first guide structure 14 is a guide bump, the second guide structure 211 is a guide groove, and the guide bump extends into the guide groove and can slide along the guide groove. In some embodiments, along the length direction of the guide groove, two opposite ends of the guide groove are closed structures, so the guide groove and the guide bump cooperate to limit the charging connector 20, preventing the charging connector 20 from falling off from the locator body 10.

In addition, the length of the guide groove and the position of the guide groove are determined according to the movement of the charging connector 20 between the accommodated position and the operation position. The relative sliding connection of the guide groove and the guide bump has a first relative position and a second relative position. When the charging connector 20 is in the accommodated position, the guide groove and the guide bump are located in the first relative position. When the guide groove and the guide bump are located in the second relative position, as shown in FIG. 8 and FIG. 10, the plug-in tongue 23 is moved out of the accommodation groove 12, and the charging connector 20 has a rotational degree of freedom that the charging connector 20 is rotatable with respect to the locator body 10 with the guide bump as an axis. The charging connector 20 may rotate with the guide bump as an axis at any position between the position shown in FIG. 8 and the position shown in FIG. 10. In order to make the charging connector 20 rotate smoothly to expose the plug-in tongue 23 and insert the plug-in tongue 23 to the corresponding interface when the guide groove and the guide bump are located in the second relative position, the side surface of the guide bump is a surface of revolution (for example, a cylindrical surface, a conical surface, and the like), so the guide bump may rotate freely in the guide groove.

As shown in FIG. 5 and FIG. 6, the operable part 21 includes a first end 212 and a second end 213 opposite to the first end 212, and the plug-in tongue 23 is arranged on the first end 212. As shown in FIG. 7, when the plug-in tongue 23 is inserted into the accommodation groove 12, and the second end 213 is away from the accommodation groove 12. As shown in FIG. 8, when the plug-in tongue 23 of the charging connector 20 is moved out of the accommodation groove 12 and the charging connector 20 is in the operation position, the second end 213 of the operable part 21 faces the bottom wall 112 of the notch 11. In some embodiments, the operable part 21 further includes a first magnetic member 214, the bottom wall 112 of the notch 11 includes a second magnetic member 1121, and the first magnetic member 214 and the second magnetic member 1121 are attracted to each other by magnetic force. The first magnetic member 214 and the second magnetic member 1121 may both are magnets. In some embodiments, one of the first magnetic member 214 and the second magnetic member 1121 is a magnet, and the other one of the first magnetic member 214 and the second magnetic member 1121 is ferromagnetic material. The ferromagnetic material may be, for example, iron, nickel, cobalt, etc. The position of the first magnetic member 214 on the operable part 21 may be determined according to actual needs. In some embodiments, the first magnetic member 214 is arranged in a position close to the second end 213. When the charging connector 20 is in the operation position, the second end 213 and the bottom wall 112 are connected by magnetic attachment of the first magnetic member 214 and the second magnetic member 1121. Therefore, a positioning effect of the charging connector 20 is achieved, the charging connector 20 is prevented from shaking when the wireless locator is charged, and a stable electrical connection between the first electrical connection structure 13 and the second electrical connection structure 22 is ensured. In some embodiments, the first magnetic member 214 is arranged in a position close to the first end 212. When the charging connector 20 is in the accommodated position, the first end 212 and the bottom wall 112 are connected by magnetic attachment of the first magnetic member 214 and the second magnetic member 1121, and thus, it is prevented that the plug-in tongue 23 falls off from the accommodation groove 12 and is damaged due to the shaking of the charging connector 20 when the charged wireless is working. In some embodiments, as shown in FIG. 7, FIG. 8, and FIG. 10, one first magnetic member 214 is arranged on a position close to the first end 212, and another first magnetic member 214 is arranged on a position close to the second end 213.

It should be noted that, the locator body 10 and the charging connector 20 may be combined in other methods. For example, the locator body 10 includes a first connection member, the charging connector 20 includes a second connection member, and when the charging connector 20 is in the operation position, the first connection member and the second connection member are connected. The first connection member and the second connection member are a socket and a plug that match each other, or are a hook and a slot corresponding to the hook.

As shown in FIG. 7, FIG. 8, and FIG. 10, in some embodiments, the first electrical connection structure 13 includes a conductive pin 131, and the second electrical connection structure 22 includes a metal pad or other conductive structure. The conductive pin 131 is provided on the side wall 111, and is spaced apart from the first guide structure 14. The conductive pin 131 is arranged on a side of the first guide structure 14 close to the bottom wall 112, and the second electrical connection structure 22 is arranged on a side of the second guide structure 211 away from the plug-in tongue 23. As shown in FIG. 7, when the charging connector 20 is in the accommodated position, the first electrical connection structure 13 and the second electrical connection structure 22 are staggered, so the first electrical connection structure 13 and the second electrical connection structure 22 are not in contact with each other, and the locator body 10 and the charging connector 20 are not electrically connected. When the charging connector 20 is in the operation position, as shown in FIG. 8, the first electrical connection structure 13 and the second electrical connection structure 22 are aligned and in contact with each other, so the locator body 10 and the charging connector 20 are electrically connected.

In some embodiments, as shown in FIG. 4, FIG. 7, FIG. 8, FIG. 10, and FIG. 11, the notch 11 includes two side walls 111, and the two side walls 111 are a first side wall 1111 and a second side wall 1112. The first side wall 1111 and the second side wall 1112 are spaced apart and disposed opposite to each other. The bottom wall 112 is connected to the first side wall 1111 and the second side wall 1112. The first side wall 1111, the second side wall 1112, and the bottom wall 112 define a concave structure of the notch 11, and the distance between first side wall 1111 and the second side wall 1112 allows the operable part 21 to be inserted into the notch 11. The operable part 21 is located between the first side wall 1111 and the second side wall 1112. In some embodiments, with ensuring that the charging connector 20 switches between the accommodated position and the operation position smoothly, the gap between the operable part 21 and the first side wall 1111 and the gap between the operable part 21 and the second side wall 1112 are as small as possible, which improves the appearance integrality of the wireless locator and improves the aesthetic of the wireless locator. The operable part 21 includes two second guide structures 211 that are disposed opposite to each other. On of the two second guide structures 211 corresponds to the first guide structure 14 on the first side wall 1111, and the other one of the two second guide structures 211 corresponds to the first guide structure 14 on the second guide structure 1112. Therefore, the operable part 21 slides smoothly in the notch 11.

As shown in FIG. 7, before charging the wireless locator, the operable part 21 is moved in the direction away from the accommodation groove 12, and the plug-in tongue 23 is taken out from the accommodation groove 12 and is moved to the position shown in FIG. 10 and FIG. 11. When the plug-in tongue 23 is completely out of the accommodation groove 12 (as shown in FIG. 10 and FIG. 11), the charging connector 20 is rotated, and the plug-in tongue 23 flips to an external side of the notch 11 and protrudes from the locator body 10 (as shown in FIG. 8). In this position, it is easy to insert the plug-in tongue 23 into a corresponding charging interface to charge the wireless locator.

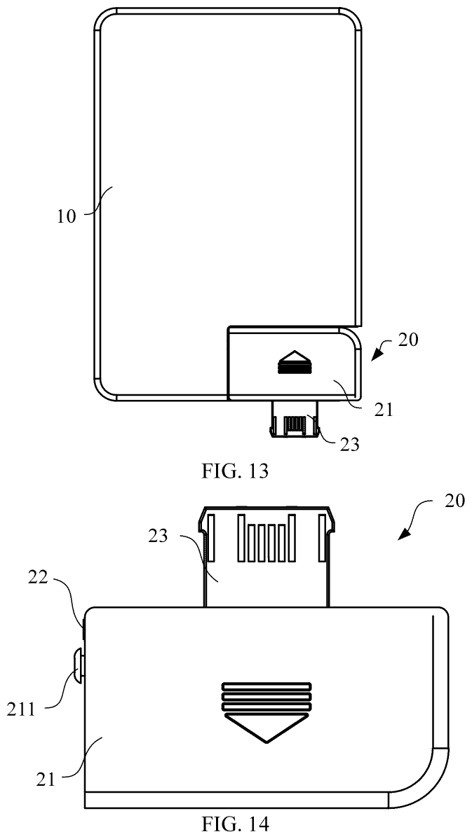

FIG. 12 is a schematic perspective view of the wireless locator when the charging connector is in the accommodated position according to another embodiment of the present disclosure. FIG. 13 is a schematic perspective view of the wireless locator when the charging connector is in the operation position according to another embodiment of the present disclosure. FIG. 14 is a perspective view of the charging connector shown in FIG. 12 and FIG. 13. In some embodiments, as shown in FIG. 12, FIG. 13, and FIG. 14, the notch 11 is arranged at a conner region of the locator body 10, and the notch 11 includes one side wall 111. A side of the charging connector 29 close to the side wall 111 is provided with a second guide structure 2111. In order to prevent separation of the charging connector 20 and the locator body 10 along the direction perpendicular to the side wall 111, the first guide structure 14 and the second guide structure 211 are designed to structures capable of preventing such separation along the direction perpendicular to the side wall 111. For example, the first guide structure 14 is a dovetail groove, and the second guide structure 211 is a guide slider having a body and a head, where the diameter of the head is greater than the body.

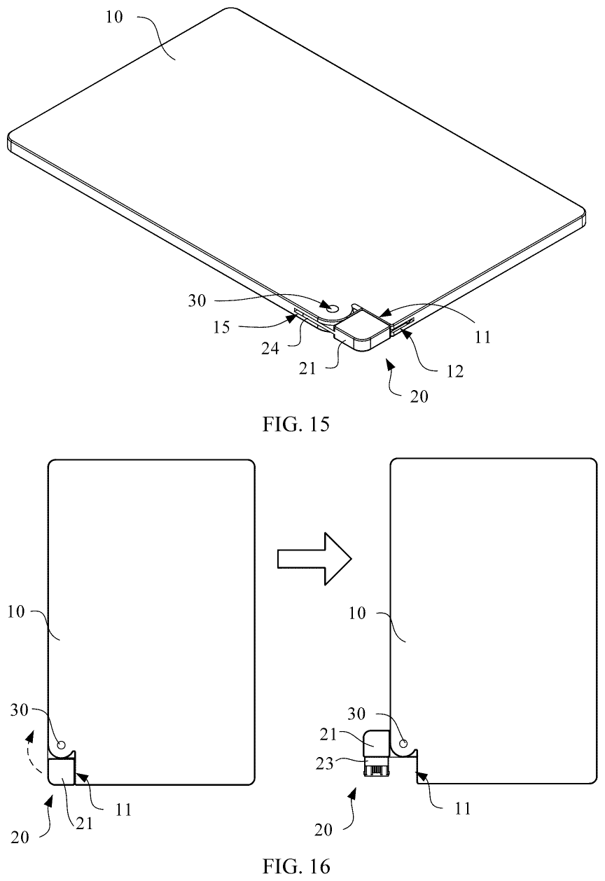

As shown in FIG. 15 to FIG. 18, in some embodiments, another movable connection manner of the charging connector 20 and the locator body 10 is provided. In this embodiment, the wireless locator further includes a rotation shaft 30, the rotation shaft 30 is perpendicular to a depth direction of the accommodation groove 12, and the charging connector 20 is rotatably connected to the locator body 10 through the rotation shaft 30. The charging connector 20 may be moved out of the accommodation groove 12 and exposed outside the locator body 10 by moving the operable part 21 by the user. As shown in FIG. 16, the charging connector 20 rotates around the rotation shaft 30 along the direction of the dashed arrow in FIG. 16, and thus, the charging connector 20 moves from the accommodated position to the operation position. In the present embodiment, the notch 11 is arranged at a corner of the locator body 10, and the accommodation groove 12 extends to the side surface, which is perpendicular to the bottom wall 112 of the notch 112, of the locator body 10 to form an opening of the side surface of the locator body 10. The charging connector 20 enters the accommodation groove 12 through this opening, or exits the accommodation groove 12 through this opening.

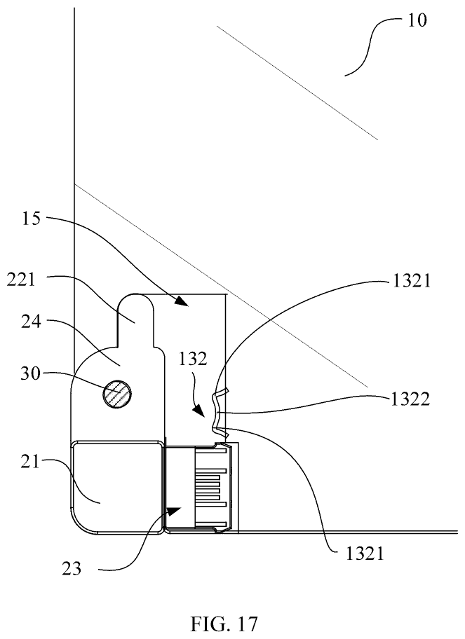

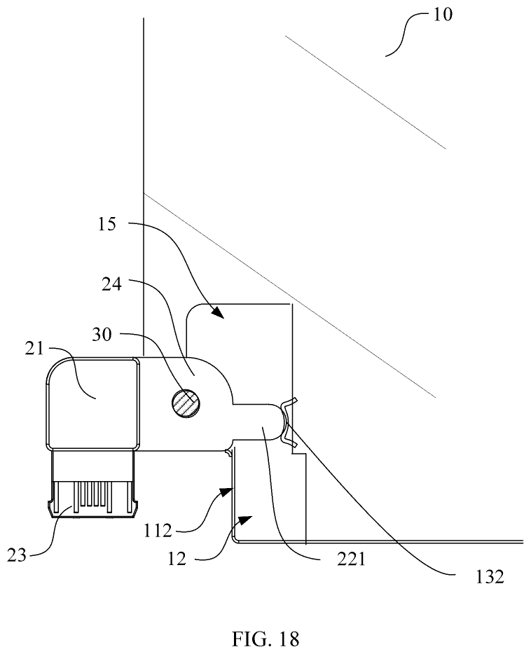

As shown in FIG. 17 and FIG. 18, the charging connector 20 further includes a connection part 24. The connection part 24 is disposed on a side of the operable part 21, and is rotatably connected to the locator body 10 through the rotation shaft 30. The connection part 24 avoids the plug-in tongue 23. Therefore, the connection part 24 does not interfere the connection between the plug-in tongue 23 and the charging interface when the wireless locator is charged. In some embodiments, as shown in FIG. 15, FIG. 17, and FIG. 18, the side wall 111 further includes an avoidance groove 15, the connection part 24 is arranged in the avoidance groove 15, and the rotation shaft 30 runs through the connection part 24 and two opposite walls of the avoidance groove 15. In this way, the connection part 24 is connected to the locator body 10.

In some embodiments, as shown in FIG. 17 and FIG. 18, the first electrical connection structure 13 includes a conductive elastic member 132, the second electrical connection structure 22 includes a connection arm 221, and the connection arm 221 is arranged on a side of the connection part 24 away from the operable part 21. The operable part 21 and the connection arm 221 are arranged in the circumferential direction of the rotation shaft 30 and form a predetermined angle. The conductive elastic member 132 is arranged on a trajectory of rotation of the connection arm 221 around the rotation shaft 30. When the charging connector 20 rotates around the rotation shaft 30, and the connection arm 221 sways around the rotation shaft 30. In this way, the connection arm 221 is connected to the conductive elastic member 132, or separated from the conductive elastic member 132.

In some embodiments, as shown in FIG. 17 and FIG. 18, the conductive elastic member 132 includes two protruding portions 1321 and a recessed portion 1322 between the two protruding portions 1321, The conductive elastic member 132 has a shape similar to “M”. The two protruding portion 1321 is arranged on the trajectory of rotation of the connection arm 221 around the rotation shaft 30. As shown in FIG. 18, when the charging connector 20 is in the operation position, the connection arm 221 is in contact with the recessed portion 1322. The two protruding portions 1321 on two sides of the recessed portion 1322 can limit the connection arm 221, ensuring the connection stability between the connection arm 221 and the conductive elastic member 132. When the charging connector 20 moves between the accommodated position and the operation position, the user applied a force on the charging connector 20, the connection arm 221 presses the protruding portions 1321 to cause elastic deformation of the protruding portions 1321. In this way, the connection arm 221 enters or exits the recessed portion 1322, that is, the connection arm 221 contacts the recessed portion 1322 or is separated from the recessed portion 1322. In response to the operation of the user, the elasticity of the recessed portion 1322 provides certain feedback to the user, and thus, the user knows whether the first electrical connection structure 13 and the second electrical structure 22 have been connected well.

Embodiments of the present disclosure provide a wireless locator. The wireless locator includes a locator body 10 and a charging connector 20. The charging connector 20 is moveably connected to the locator body 10. The charging connector 20 is provided a plug-in tongue 23, and the plug-in tongue 23 may be accommodated in the accommodation groove 12 of the locator body 10, ensuring the neatness and cleanliness of the appearance of the wireless locator. When the wireless locator is being charged, the plug-in tongue 23 is moved out from the accommodation groove 12, the first electrical connection structure 13 of the locator body 10 is connected to the second electrical connection structure 22 of the charging connector 29, and the plug-in tongue 23 is connected to an external power interface. In this way, the rechargeable battery 16 of the wireless locator is charged. The plug-in tongue 23 may be a universal charging interface, which improves the charging flexibility of the wireless locator without increasing the thickness of the wireless locator.

The above embodiments are exemplary embodiments of the present disclosure and are not intended to limit the present disclosure. The present disclosure may be subject to various modifications and variations to those skilled in the art. Any modifications, equivalent substitutions or improvements that are within the spirit and principle of the disclosure are intended to be covered by the protection scope of the disclosure.

I/We claim:

1. A wireless locator, comprising:
a locator body; and
a charging connector moveably connected to the locator body,
wherein the locator body comprises a notch, a first electrical connection structure, and a rechargeable battery electrically connected to the first electrical connection structure,
wherein the notch comprises at least one side wall and a bottom wall connected to the at least one side wall, the bottom wall comprises an accommodation groove,
wherein the charging connector comprises an operable part, a second electrical connection structure, and a plug-in tongue, the plug-in tongue is connected to the operable part, and the second electrical connection structure is electrically connected to the plug-in tongue,
wherein the charging connector has an accommodated position and an operation position,
when the charging connector is in the accommodated position, the operable part is accommodated in the notch, the plug-in tongue is accommodated in the accommodation groove, and the second electrical connection structure is separated from the first electrical connection structure, and
when the charging connector is in the operation position, the plug-in tongue is out of the accommodation groove and protrudes from the locator body, and the second electrical connection structure is connected to the first electrical connection structure.

2. The wireless locator according to claim 1, wherein each side wall comprises a first guide structure, an extending direction of the first guide structure intersects the bottom wall, the operable part comprises a second guide structure, and the second guide structure and the first guide structure are in a sliding connection.

3. The wireless locator according to claim 2, wherein the at least one side wall of the notch comprises a first side wall and a second side wall, the first side wall and the second side wall are spaced apart and disposed opposite to each other, the bottom wall is connected to the first side wall and the second side wall, and the operable part is disposed between the first side wall and the second side wall,
the operable part comprises two second guide structures, one of the two second guide structures corresponds to the first guide structure of the first side wall, and the other one of the two second guide structures corresponds to the first guide structure of the second side wall.

4. The wireless locator according to claim 2, wherein the first guide structure is a guide groove, an extending direction of the guide groove intersects the bottom wall, the second guide structure is a guide bump, and the guide groove and the guide bump are in a sliding connection.

5. The wireless locator according to claim 4, wherein the sliding connection of the guide groove and the guide bump has a first relative position and a second relative position,
when the charging connector is in the accommodated position, the guide groove and the guide bump are located in the first relative position,
when the guide groove and the guide bump are located in the second relative position, the charging connector has a rotational degree of freedom that the charging connector is rotatable with respect to the locator body with the guide bump as an axis.

6. The wireless locator according to claim 2, wherein the first guide structure is a guide bump, the second guide structure is a guide groove, and the guide groove and the guide bump are in a sliding connection.

7. The wireless locator according to claim 6, wherein the sliding connection of the guide groove and the guide bump has a first relative position and a second relative position,
when the charging connector is in the accommodated position, the guide groove and the guide bump are located in the first relative position,
when the guide groove and the guide bump are located in the second relative position, the charging connector has a rotational degree of freedom that the charging connector is rotatable with respect to the locator body with the guide bump as an axis.

8. The wireless locator according to claim 2, wherein the first electrical connection structure comprises a conductive pin provided on the side wall, the conductive pin is spaced apart from the first guide structure and arranged on a side of the first guide structure close to the bottom wall, and the second electrical connection structure is arranged on a side of the second guide structure away from the plug-in tongue.

9. The wireless locator according to claim 1, wherein the charging connector is rotatably connected to the locator body via a rotation shaft, and the rotation shaft is perpendicular to a depth direction of the accommodation groove.

10. The wireless locator according to claim 9, wherein the charging connector further comprises a connection part, the connection part is disposed on a side of the operable part and is rotatably connected to the locator body via the rotation shaft, and the connection part avoids the plug-in tongue.

11. The wireless locator according to claim 10, wherein the side wall is further provided with an avoidance groove, the connection part is arranged in the avoidance groove, and the rotation shaft runs through the connection part and two opposite walls of the avoidance groove.

12. The wireless locator according to claim 10, wherein the first electrical connection structure comprises a conductive elastic member, the second electrical connection structure comprises a connection arm, the connection arm is arranged on a side of the connection part away from the operable part, and the conductive elastic member is arranged on a trajectory of rotation of the connection arm around the rotation shaft.

13. The wireless locator according to claim 12, wherein the conductive elastic member comprises two protruding portions and a recessed portion between the two protruding portions, the two protruding portions are arranged on the trajectory of rotation of the connection arm around the rotation shaft,
when the charging connector is in the operation position, the connection arm is in contact with the recessed portion, and
when the charging connector moves between the accommodated position and the operation position, the connection arm presses the protruding portions to cause elastic deformation of the protruding portions.

14. The wireless locator according to claim 2, wherein the operable part comprises a first end and a second end opposite to the first end, the plug-in tongue is arranged on the first end, the operable part is further provided with a first magnetic member, and the bottom wall is provided with a second magnetic member, and
wherein when the charging connector is in the operation position, the second end and the bottom wall are connected by magnetic attachment of the first magnetic member and the second magnetic member, and/or, when the charging connector is in the accommodated position, the first end and the bottom wall are connected by magnetic attachment of the first magnetic member and the second magnetic member.

15. The wireless locator according to claim 1, wherein the locator body further comprises a first connection member, the charging connector comprises a second connection member, and when the charging connector is in the operation position, the first connection member is connected to the second connection member.

16. The wireless locator according to claim 1, wherein the locator body further comprises a control circuit electrically connected to the rechargeable battery, the control circuit comprises a power management circuit and a positioning circuit, the power management circuit is electrically connected to the first electrical connection structure and the rechargeable battery, and the positioning circuit is in wireless communication with an external device.

17. The wireless locator according to claim 16, wherein the locator body further comprises a sounding device electrically connected to the control circuit.

18. The wireless locator according to claim 1, wherein the wireless locator has an extended flat box shape, the notch runs through the locator body along a thickness direction of the wireless locator,
when the plug-in tongue is accommodated in the accommodation groove, the plug-in tongue is perpendicular to the thickness direction of the wireless locator.
